(19) United States
(12) Patent Application Publication
(10) Pub. No.: US 2009/0031023 A1
(43) Pub. Date: Jan. 29, 2009

(54) Digital File Path Tracker (DFPT) Technology for Tracking Comsumption of Digital Content

(76) Inventor: Meshulam Golovinski, Ra'anana (IL)

Correspondence Address: THE NATH LAW GROUP, 112 South West Street, Alexandria, VA, 22314, US

(21) Appl. No.: 12/223,581

(22) PCT Filed: Feb. 11, 2007
(86) PCT No.: PCT/IL2007/000186

§ 371 Date: Aug. 4, 2008

Related U.S. Application Data
(60) Provisional application No. 60/771,852, filed on Feb. 10, 2006.

(51) Int. Cl. G06F 15/16; H04L 9/00

(52) U.S. Cl. 709/224; 380/255

(57) ABSTRACT

Digital File Path Tracker (DF′PT) technology for tracking consumption of digital content for business information purposes, digital content distribution purposes, online multiplayer gaming environments, and the like. Tracking consumption of digital content is achieved by provisioning digital files with a so-called DF′PT for including consumption information regarding their Server consumption, and providing a DFTP mechanism for iteratively updating DFPTs.

### CROSS-REFERENCE TO RELATED APPLICATIONS

This application is the national phase application of International Application PCT/IL2007/000186 filed on 11 Feb. 2007, the contents of which are incorporated herein by reference; which application in turn claims priority on U.S. provisional application 60/771,852 filed 10 Feb. 2006, the contents of which are incorporated herein by reference.

### FIELD OF THE INVENTION

The invention relates to digital content consumption.

### BACKGROUND OF THE INVENTION

Wide acceptance of broadband Internet has now enabled massive consumption of digital content including inter alia computer programs, data files, media content, and the like. Some digital content requires a license from a Digital Rights Manager (DRM) server/service for viewing purposes using suitable commercially available viewers including inter alia Microsoft Office, eBook, Adobe Acrobat, Windows Media Player, Real Player, Itunes, and the like. Exemplary DRM servers/services include inter alia Microsoft DRM, Apple, Real, and the like. Some licenses are available free of charge, say, after user registration whilst other require purchasing. Media content typically requires purchasing a license to be legally viewed. On-line purchases of licenses for digital content can be cleared at a clearance server. Clearance servers are commercially available from Tranzilla, Paypal, and the like. Pirating of digital content intended to be viewed under a purchased license is leading to revenue loss and is a major concern for digital content owners.

### SUMMARY OF THE INVENTION

Generally speaking, the present invention is directed toward Digital File Path Tracker (DFPT) technology for tracking consumption of digital content for business information purposes, digital content distribution purposes, online multiplayer gaming environments, and the like. Tracking consumption of digital content is achieved by provisioning digital files with a digital file path tracker for including a digital representation of consumption information regarding the consumption of the digital file, and providing a DFPT mechanism for iteratively updating DFPTs. For the purpose of better understanding the present invention, the specification and appended claims employ the following terms:

Digital file: Digital files containing digital content and a DFPT for including consumption information. DFPTs can include pointers for pointing to records on a DFPT server for storing consumption information regarding digital files or actual consumption information. DFPTs can be embedded at any location in a digital file but are preferably located at readily accessible locations, for example, headers, footers, and the like. DFPTs can be entirely unencrypted, partially encrypted, or entirely encrypted depending on inter alia security requirements, computing environment, business application, and the like.

DFPT mechanism: DFPT mechanisms can be implemented in accordance with any one of the following list: a-DFPT server and thin DFPT clients, DFPT clients only, and a DFPT server only. DFPT mechanisms include computer executable code for iteratively updating DFPTs for tracking consumption of digital content. DFPT clients can be either discrete client applications for residing on host computing devices or integrally included in operating systems, for example, Windows, and the like.

Computing device: Devices enabling consumption of digital files. Computing devices include a DFPT client and/or a connection to a DFPT server. Computing devices can be connected over distribution networks, for example, LANs, WANs, the Internet, and the like. Computing devices can be personal computers, PDAs, so-called smart phones, personal cellular telecommunications devices having computing capabilities, and the like. Computing devices also include thin terminals connected to a central server.

File transaction: File transactions include online file transactions and offline file transactions. Online file transactions include inter alia uploading a digital file onto a server and/or downloading a digital file from a server and/or receiving a digital file and/or rendering contents of a digital file and/or transmitting a digital file. Rendering contents of digital files includes inter alia viewing digital content, listening to digital content, processing digital content, and the like. Accordingly, DFPTs are updated when a digital file is uploaded to a server, downloaded from a server, received and/or transmitted by email, each instance of a digital file is opened for rendering purposes, and the like. Offline file transactions include inter alia copying digital files onto physical computer medium, copying files to and from external hard drives, and the like.

Consumption: Execution of at least one file transaction on a digital file. Depending on particular business logic, content consumers can consume the same digital content at two or more different computing devices. Similarly, two different content consumers can consume the same digital content at the same computing device.

Content owner: Content owners have rights to distribute digital files and/or are the originators of new content distribution paths for distributing digital content. Content owners can have rights to distribute digital files by virtue of them originating the digital files or suitable legal means including assignment, licensing, and the like. Content owners can be physical persons or legal entities. Content owners are preferably identified by unique owner identifiers. Content owners of some digital files can be content consumers of other digital files, and vice versa.

Content consumer: Content consumers are either users employing computing devices to consume digital content or computing devices consuming digital content in accordance with predetermined business logic. Content consumers are preferably identified by unique consumer identifiers. Content consumers of some digital files can be content owners of other digital files, and vice versa.

Content distribution path: Sequence of content consumers which performed at least one file transaction on a digital file. Content distribution paths may or may not include content owners.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a block diagram of a first preferred embodiment of a DFPT mechanism for tracking consumption of digital content;

FIG. 2 is a flow diagram of a top level methodology for tracking consumption of digital content;

FIG. 3 is a schematic diagram showing viral distribution of three original digital files from their content owners to content consumers;

FIG. 4 is a table showing DFPTs of original digital files and file instances for FIG. 3's viral distribution in accordance with a first preferred DFPT technique for tracking consumption of digital content;

FIG. 5 is a table showing DFPTs of original digital files and file instances for FIG. 3's viral distribution in accordance with a second preferred DFPT technique for tracking consumption of digital content;

FIG. 6 is a table showing DFPTs of original digital files and file instances for FIG. 3's viral distribution in accordance with a third preferred DFPT technique for tracking consumption of digital content;

FIG. 7 is a table showing DFPTs of original digital files and file instances for FIG. 3's viral distribution in accordance with a fourth preferred DFPT technique for tracking consumption of digital content;

FIG. 8 is a block diagram of a second preferred embodiment of a DFPT mechanism for tracking consumption of digital content;

FIG. 9 is a block diagram of a DFPT client of FIG. 8's DFPT mechanism;

FIG. 10 is a block diagram of a third preferred embodiment of a DFPT mechanism for tracking consumption of digital content; and

FIG. 11 is a schematic diagram of viral distribution of digital content.

### DETAILED DESCRIPTION OF PREFERRED EMBODIMENTS OF THE PRESENT INVENTION

### DFPT Mechanism Including DFPT Server and Thin DFPT Clients

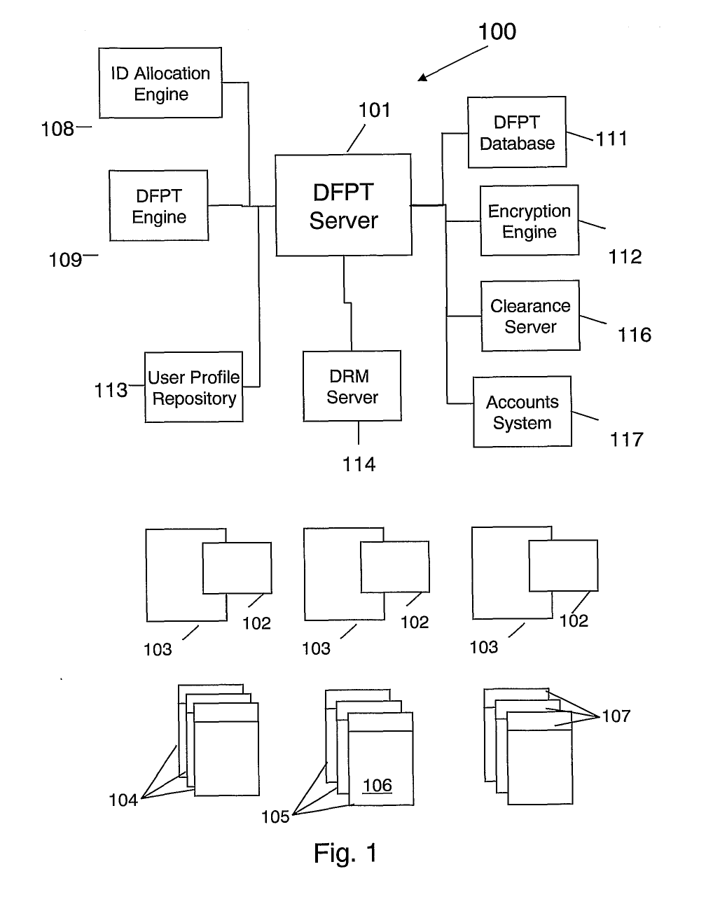

FIG. 1 shows a DFPT mechanism 100 including a DFPT server 101 and thin DFPT clients 102 residing on computing devices 103. The computing devices 103 are each capable of receiving digital files 104, rendering digital files 104, and transmitting digital files 104. The digital files 104 each include a file identifier 105, digital content 106 and at least one DFPT 107 for including consumer identification information regarding at least one content consumer which performed at least one file transaction. DFPTs 107 can include metadata regarding content consumers. Metadata can include a wide range of data in accordance with predetermined business logic.

The DFPT server 101 preferably includes an identification (ID) allocation engine 108 for managing unique ID allocation to content owners and content consumers. Alternatively, discrete DFPT client applications 102 can be provided with predetermined ID numbers. Alternatively, computing devices 103 with reinstalled operating systems can have pre-installed DFPT clients with preallocated IDS.

The DFPT server 101 includes a DFPT engine 109 for determining new DFPTs 107 for digital files pursuant to each file transaction thereon, and a DFPT database 111 for storing DFPTs 107 for data analysis purposes regarding individual digital files and/or system wide digital content distribution. Data analysis regarding individual digital files includes inter alia content distribution paths, and data logs including, for example, time stamps when digital files were received and transmitted, times and durations of rendering of digital files, and the like. Data analysis regarding system wide digital content distribution includes inter alia the total number of content consumers of digital content, say, a film, a song, an ebook, and the like, a list of content consumers who massively distributed digital content to other content consumers, billing purposes, revenue sharing purposes, socio-commercial information regarding social contacts between content owners and content consumers, and the like.

The DFPT server 101 can optionally include an encryption engine 112 for encrypting DFPTs 107 in accordance with predetermined business logics, and a user profile repository 113 for storing details regarding users 7 personal details, for example, age, sex, contact details, and the like, and personal preferences, for example, hobbies, interests, dislikes, and the like. Moreover, the DFPT server 101 can execute integrity checks for determining whether DFPTs have been illegally tampered with. Such integrity checks can provide information regarding which computing devices tampered with DFTPs, when they tampered with DFTPs, and the like.

The DFPT server 101 can optionally handshake with a DRM server 114 for issuing licenses for enabling content consumers to render licensed digital content, and a clearance server 116 for charging payments for licensed digital content. The DFPT server 101 can also include an accounts system 117 for managing accounts regarding consumption of digital content.

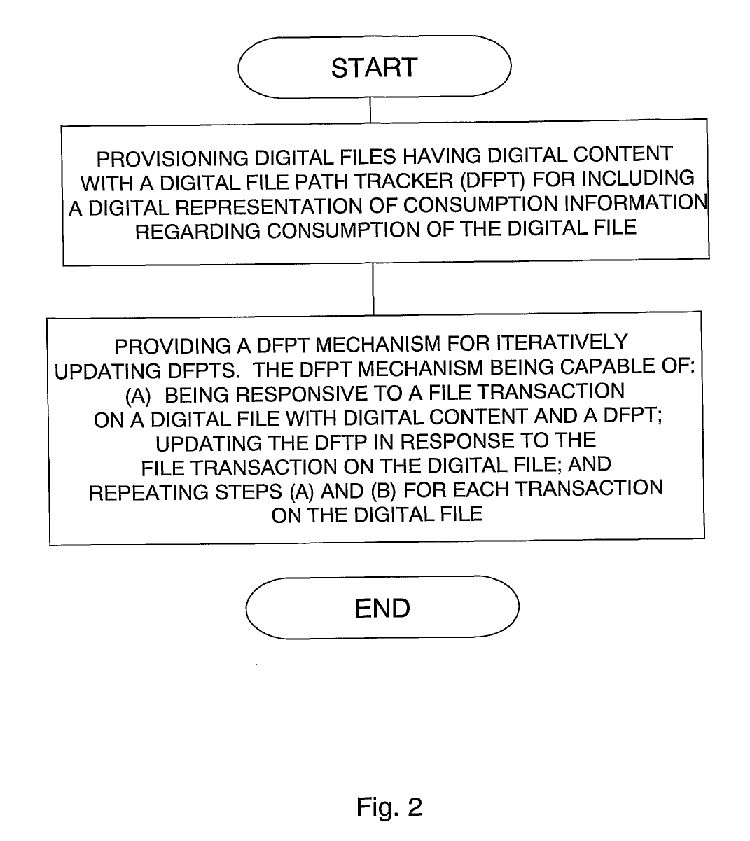

FIG. 2 shows tracking consumption of digital content in accordance with the present invention includes provisioning digital files having digital content with a DFPT for including a digital representation of consumption information regarding the consumption of the digital file, and providing a DFPT mechanism capable of executing the steps of: (a) being responsive to a file transaction on a digital file with digital content and a DFPT for including consumption information regarding consumption of the digital file, (b) updating the digital file path tracker in response to the file transaction in step (a), and (c) repeating steps (a) and (b) for each file transaction on the digital file.

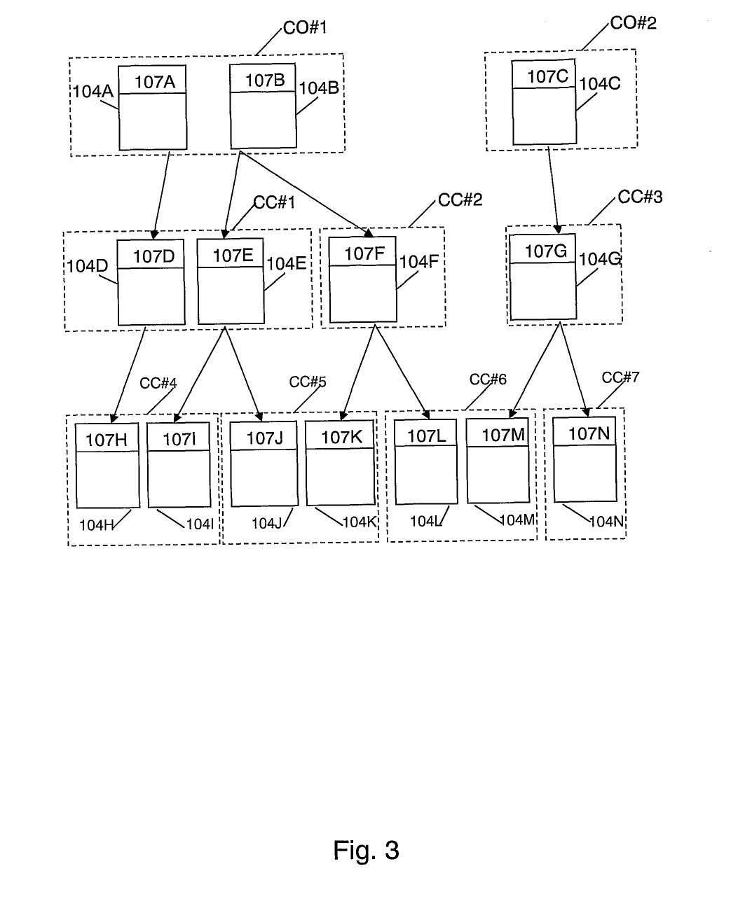

FIG. 3 shows viral distribution of three original digital files 104A7 104B and 104C from a pair of content owners CO#1 and CO#2 to seven content consumers CC#1 to CC#7. The content owners CO#1 and CO#2 and the seven content consumers CC#1 to CC#7 are shown in dashed lines. The content owner CO#1 owns the digital file 104A with a DFPT 107A and the digital file 104B with a DFPT 107B, and the content owner CO#2 owns the digital file 104C with a DFPT 107C. The content owner CO#1 distributes his digital files 104A and

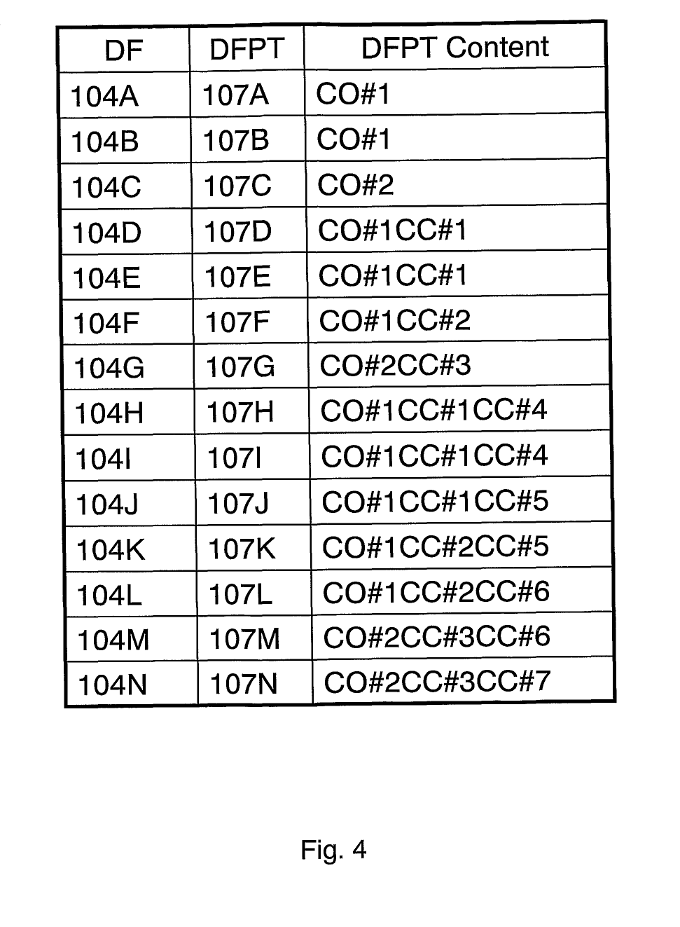

104B to the content consumer CC#1 to create file instances 104D and 104E with DFPTs 107D and 107E, respectively, and his digital file 104B to the content consumer CC#2 to create a file instance 104F with a DFPT 107E The content owner CO#2 distributes his digital file 104C to the content consumer CC#3 to create a file instance 104G with a DFPT 107G. The content consumer CC#1 distributes his file instances 104D and 104E to the content consumer CC#4 to create file instance 104H and 1041 with DFPTs 107H and 1071, respectively, and his file instance 104E to the content consumer CC#5 to create a file instance 1045 with a DFPT 107J. The content consumer CC#2 distributes his file instance 104F to the content consumer CC#5 to create a file instance 104K with a DFPT 107K and the content consumer CC#6 to create a file instance 104L with a DFPT 107L. The content consumer CC#3 distributes his file instance 104G to the content consumer CC#6 to create a file instance 104M with a DFPT 107M, and the content consumer CC#7 to create a file instance 104N with a DFPT 107N. FIGS. 4 to 7 show tables of DFPTs 107A to 107N of the original digital files 104A to 104C and the file instances 104D to 104N for FIG. 3's viral distribution for four exemplary DFPT techniques of progressively increasing security. However, it can be readily appreciated by those in the art that other
DFPT techniques can be readily employed for updating DFPTs with consumption information regarding digital files. Moreover, certain DFPT techniques are more suitable for DFPTs which include actual consumption information whilst other DFPT techniques are more suitable for DFPTs which include pointers to records on a DFPT server.

FIG. 4 is a table listing DFPTs 107A to 107N of the original digital files 104A to 104C and the file instances 104D to 104N for FIG. 3's viral distribution for a DFPT technique based on digital representations of consumer identification information including an initial unencrypted content owner identifier owning a digital file and a chronological order of unencrypted consumer identifiers of all the content consumers which consumed the digital file. This DFPT technique renders file instances originating from different digital files following the same content distribution path having the same DFPTs. For example, DFPT 107D and DFPT 107E are identical as are 107H and 1071.

Contrastingly, file instances originating from the same digital file or same file instance at different content consumers have different DFPTs since they include their last consumer identifiers. For example, DFPT 107E and DFPT 107F are different as are DFPT 107K and DFPT 107L.

This approach is suitable for distribution applications in which it is advantageous that content distribution paths can be readily understood. Exemplary distribution applications include inter alia viewing Word documents, PowerPoint presentations, and the like. In this case, metadata can include inter alia data logs regarding the times and durations different content consumers rendered the digital file for billing purposes, and the like. This approach is also suitable for business environments in which content owners are unconcerned that content consumers can change DFPTs.

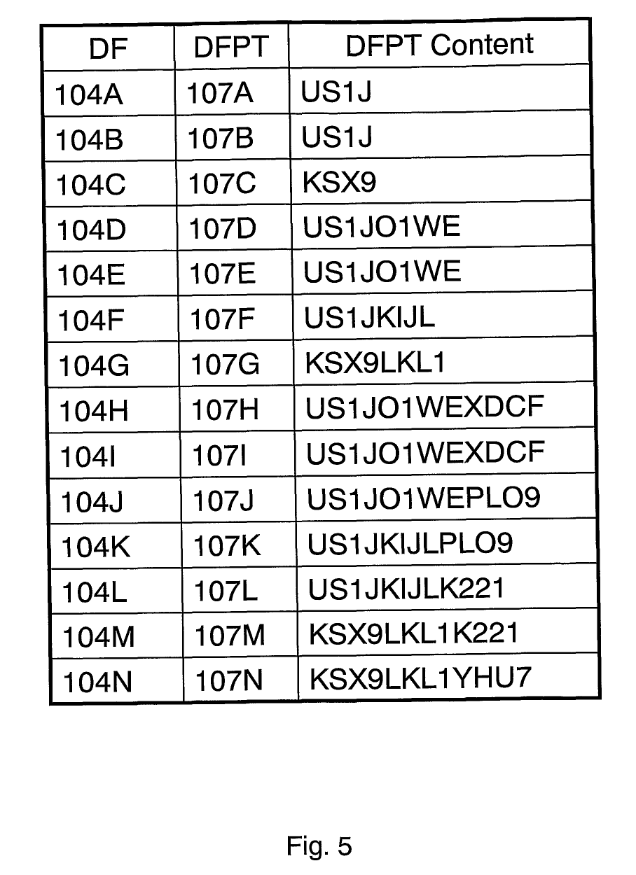

FIG. 5 is a table listing DFPTs 107A to 107N of the original digital files 104A to 104C and the file instances 104D to 104N for FIG. 3's viral distribution for a DFPT technique similar to FIG. 4's DFPT technique except that the content owner identifiers CO#1 and CO#2 and the content consumer identifiers CC#1 to CC#7 are individually encrypted. The encryption legend is as follows:

| | |
|---|---|
| CO#1 | USlJ |
| C0#2 | KSX9 |
| CC#1 | OlWE |
| CC#2 | KIJL |
| CC#3 | LKLl |
| CC#4 | XDCF |
| CC#5 | PL09 |
| CC#6 | K221 |
| CC#7 | YHU7 |

Similar to FIG. 4's DFPT technique, file instances originating from different digital files following the same content distribution path have the same DFPTs, for example, DFPT 107D and DFPT 107E are identical as are 107H and 1071. Also, file instances originating from the same digital file or file instance at different content consumers have different DFPTs since they include their last consumer identifiers, for example, DFPT 107E and DFPT 107F are different as are DFPT 107K and DFPT 107L.

FIG. 5's DFPT technique is advantageous over FIG. 4's DFPT technique insofar as a content consumer does not know the identities of previous content consumers of a file instance in his possession without possession of the encryption legend. This approach is particularly suitable for tracking content distribution paths of particular file instances of digital paths.

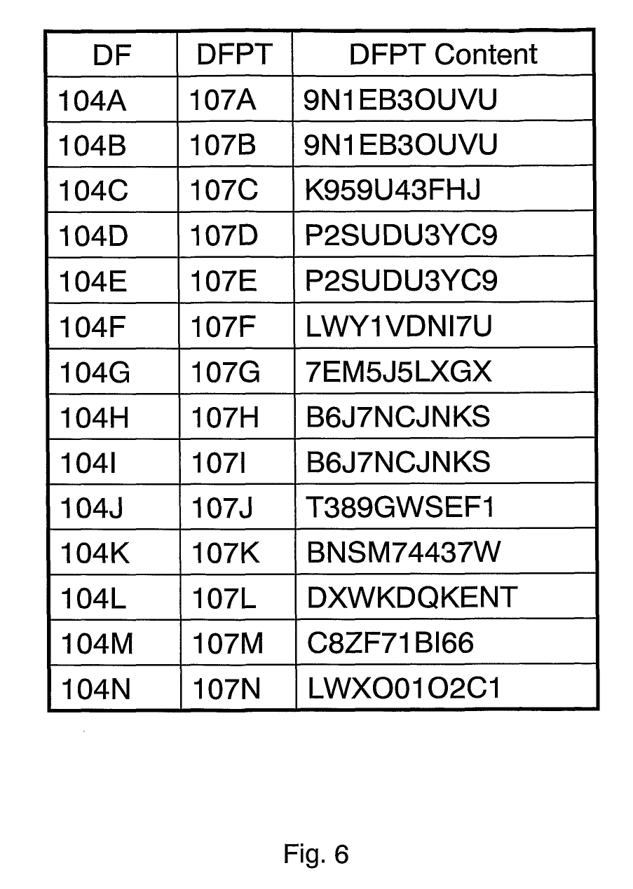

FIG. 6 is a table listing DFPTs 107A to 107N of the original digital files 104A to 104C and the file instances 104D to 104N for FIG. 3's viral distribution for a DFPT technique in which digital representations of consumer identification information are wholly encrypted. The DFPTs 107A to 107N are preferably of uniform length irrespective of the number of content consumers which consumed a digital file which is advantageous in terms of DFPT overhead.

Similar to FIG. 4's DFPT technique, file instances originating from different digital files following the same content distribution path have the same DFPTs, for example, DFPT 107D and DFPT 107E are identical as are 107H and 1071. Also, file instances originating from the same digital file or file instance at different content consumers have different DFPTs since they include their last 25 consumer identifiers, for example, DFPT 107E and DFPT 107F are different as are DFPT 107K and DFPT 107L.

FIG. 6's DFPT technique is particularly suitable for pay media content viral distribution since DFPTs are unable to be deciphered without the correct encryption algorithm thereby precluding users from understanding the number of content consumers along a content distribution path and/or his position therealong.

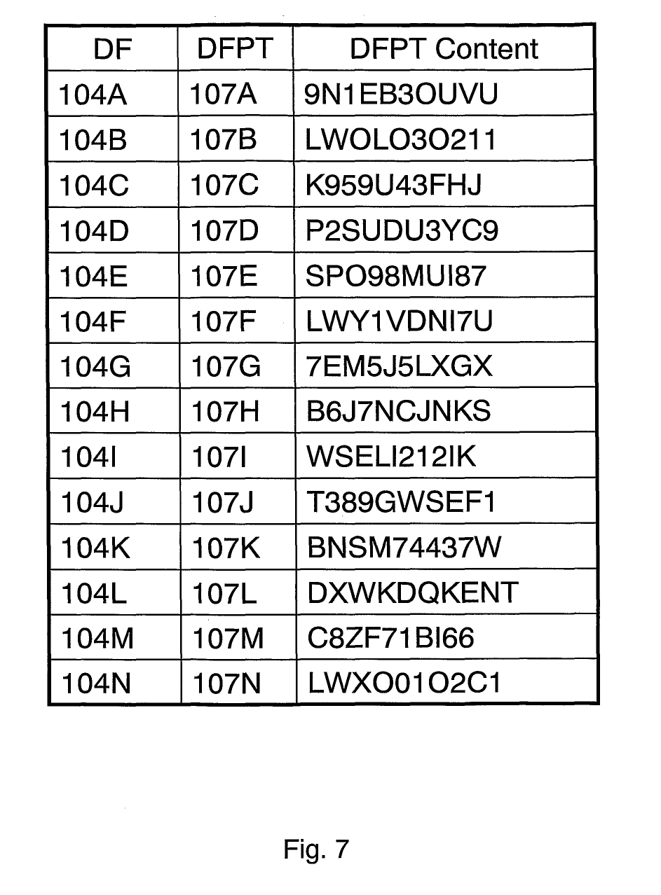

FIG. 7 is a table listing DFPTs 107A to 107N of the original digital files 104A to 104C and the file instances 104D to 104N for FIG. 3's viral distribution for a DFPT technique similar to FIG. 6's DFPT technique except that digital representations additionally include a file identifier. Also similar to FIG. 6's DFPT technique, the DFPTs 107A to 107N are preferably of uniform length irrespective of the number of content consumers which consumed a digital file. However, in this case, each file instance has a unique DFPT such that FIG. 7's DFPT technique is particularly suitable for pay media content viral distribution since DFPTs are unable to be deciphered with the correct encryption algorithm.

### DFPT Mechanism Including Standalone DFPT Clients Only

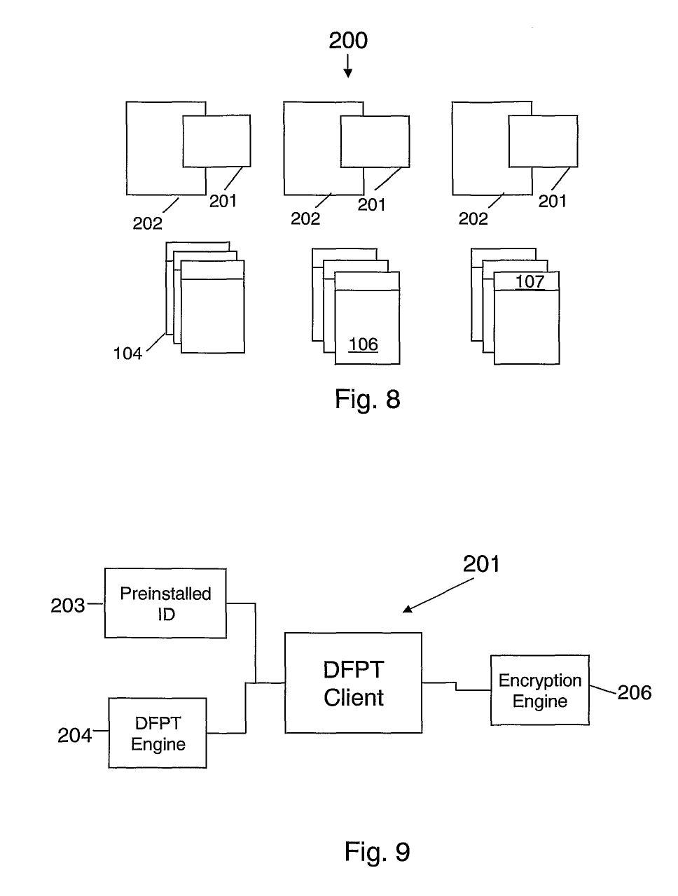

FIG. 8 shows a DFPT mechanism 200 including standalone DFPT clients 201 for tracking consumption of individual digital files. The DFPT clients 201 reside on computing devices 202 each capable of receiving digital files 104, rendering digital files 104, and transmitting digital files 104. FIG. 9 shows DFPT clients 201 include a pre-installed ID 203, a DFPT engine 204 for determining new DFPTs 107 for digital files pursuant to at least one file transaction, and optionally include an encryption engine 206. DFTP mechanisms 200 are particularly suitable for enterprise computing environments, and antipiracy purposes.

### DFPT Mechanism Including Standalone DFPT Server Only

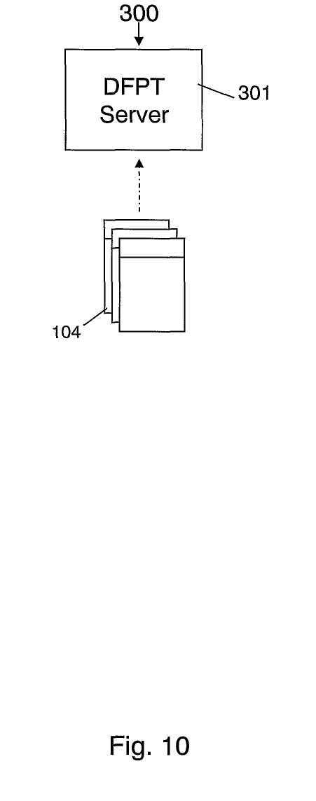

FIG. 10 shows a DFPT mechanism 300 including a standalone DFPT server 301 similar to the DFPT server 101 for tracking consumption of digital content. The DFPT mechanism 300 is particularly suitable for online multiplayer gaming environments.

### Digital Content Distribution Applications

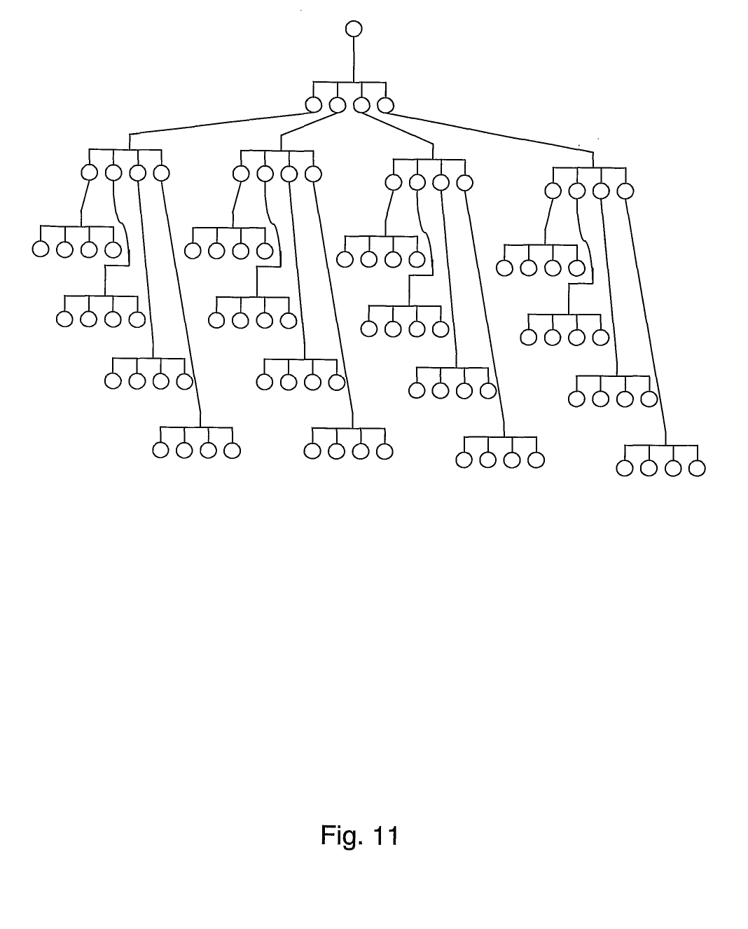

FIG. 11 shows viral distribution from a single Level 0 content owner to four Level 1 content consumers who each in turn distribute to four Level 2 content consumers who each in turn distribute to four Level 3 content consumers making a total of 64 Level 3 content consumers. DFPT technology can be readily adapted for a wide range of digital content distribution applications as follows:

1. Viral Distribution of Unlicensed Digital Content

For example, the World Health Organization (WHO) acting as the Level 0 content owner may employ viral distribution to disseminate an anti-smoking campaign. The DFPT technology of the present invention can be employed for determining the number of users who viewed the anti-smoking campaign, their locations, ages, and the like. Viral distribution of unlicensed digital content typically employs DFPT techniques with relatively low security.

2. Paid Viral Distribution of Digital Content

Content owners, for example, advertising agencies, can distribute original digital files to Level 1 content consumers and reward them to view and forward same to Level 2 content consumers who in turn view and forward same to Level 3 content consumers etc. Content owners can reward lower level content consumers such that they are also encouraged to view and forward adverts.

Content owners can reward content consumers less if they view adverts only or forward adverts only. Paid viral distribution of digital content typically employs DFPTs with one of the encrypted DFTP techniques to preclude tampering with same which would affect payments to content consumers.

3. Revenue Share Viral Distribution of Licensed Digital Content

Content owners, for example, media content labels, on-line publishers, and the like, can enable content consumers to download content media from a website and view same on purchasing a license whereupon the content consumers receive a file instance with a DFPT preferably employing the fourth DFTP technique to prevent piracy. Content owners can encourage viral distribution of the licensed file instances by revenue sharing. For example, content consumers can purchase licenses at USD 1 each either directly from a content owner in which case the content owner receives the full purchase price or from content consumer in which in the case the purchase price can be split between the content owner and content consumers along the content distribution path of a file instance being purchased by a new content consumer. The same purchaser can be, say, a Level 3 content consumer for some media content and a Level 8 content consumer for other media content and correspondingly receive different revenue for each purchase of media content either directly or indirectly from him. The DFPT server can manage accounts for content consumers and enable content consumers to use revenue for future purchases.

### Online Multiplayer Gaming Environments

DFPT technology is readily applicable to online multiplayer gaming environments, for example, Second Life (www.secondlife.com), enabling online players to create so-called avatars living in a virtual world including virtual commerce in products and services. DFPT technology enables avatars to become content owners for offering virtual goods and services for sale to other avatars, and content consumers of same, and tracking consumption of the virtual goods and services for billing purposes, moderation purposes, and the like.

While the invention has been described with respect to a limited number of embodiments, it will be appreciated that many variations, modifications, and other applications of the invention can be made within the scope of the appended claims.

I claim:

1. A digital file comprising digital content and a digital file path tracker for including a digital representation of consumption information regarding consumption of the digital file.

2. The file according to claim 1, wherein the digital representation of consumption information is constituted by a pointer pointing to a record on a digital file path tracker server including digital file path tracker records regarding consumption of digital files.

3. The file according to claim 1, wherein the digital representation of consumption information includes information regarding content consumers which consumed the digital file.

4. The file according to claim 3, wherein the digital representation of consumption information includes information regarding the content owner of the digital file.

5. The file according to claim 4, wherein the digital representation of consumption information includes a file identifier of the digital file.

6. The file according to claim 1, wherein at least a portion of the digital representation of consumption information is encrypted.

7. The file according to claim 1, wherein a user consumes the digital file.

8. The file according to claim 1, wherein a computing device consumes the digital file.

9. A digital file path tracker mechanism for use with digital files in accordance with claim 1, the mechanism capable of executing the steps of:
(a) being responsive to a file transaction on a digital file with digital content and a digital file path tracker;
(b) updating the digital file path tracker in response to the file transaction in step (a); and
(c) repeating steps (a) and (b) for each file transaction on the digital file.

10. The mechanism according to claim 9 and comprising a digital file path tracker server.

11. The mechanism according to claim 10, wherein the digital file path tracker server includes a digital file path tracker engine for determining new digital file path trackers for digital files pursuant to each file transaction thereon.

12. The mechanism according to claim 10, wherein the digital file path tracker server includes a digital file path tracker database for storing digital file path tracker records regarding consumption of digital files.

13. The mechanism according to claim 10, wherein the digital file path tracker includes an identification allocation engine for managing unique identification allocation to content owners and content consumers.

14. The mechanism according claim 10, wherein the digital file path tracker server includes a user profile repository for storing details regarding users ‘personal details.

15. The mechanism according to claim 10, wherein the digital file path tracker server includes an encryption engine for encrypting digital file path trackers.

16. The mechanism according to claim 10, wherein the digital file path tracker server executes integrity checks on digital file path trackers.

17. The mechanism according to claim 10, wherein the digital file path tracker server manages an accounting system regarding consumption of digital content.

18. The mechanism according to claim 10 and further comprising at least one digital file path tracker client for residing on a corresponding number of computing devices for consuming digital content and capable of communication with the digital file path tracker server.

19. The mechanism according to claim 9 and comprising at least one standalone digital file path tracker client for residing on a corresponding number of computing devices for consuming digital content.

20. A digital content distribution application for distributing digital content, the application comprising a digital file path tracker mechanism according to claim 9 for tracking consumption of digital content.

21. An online multiplayer gaming environment comprising a digital file path tracker mechanism according to claim 9 for tracking consumption of virtual goods and services in a virtual world.

22. A method for tracking consumption of digital content, the method comprising the steps of:
(a) provisioning a digital file in accordance with claim 1; and
(b) providing a digital file path tracker mechanism capable of executing the steps of:
(i) being responsive to a file transaction on a digital file with digital content and a digital file path tracker;
(ii) updating the digital file path tracker in response to the file transaction in step (i); and
(iii) repeating steps (i) and (ii) for each file transaction on the digital file.

23. The method according to claim 22 and further comprising the step of: determining new digital file path trackers for digital files pursuant to each file transaction thereon.

24. The method according to claim 22 and further comprising the step of storing digital file path tracker records regarding consumption of digital files.

25. The method according to claim 22 and further comprising the step of managing unique identification allocation to content owners and content consumers.

26. The method according to claim 22 and further comprising the step of providing a user profile repository for storing details regarding users' personal details.

27. The method according to claim 22 and further comprising the step of providing an encryption engine for encrypting digital file path trackers.

28. The method according to claim 22 and further comprising the step of executing integrity checks on digital file path trackers.

29. The method according to claim 22 and further comprising the step of managing an accounting system regarding consumption of digital content.

30. A digital content distribution application operative according to claim 22 for tracking consumption of digital content.

31. An online multiplayer gaming environment operative according to claim 22 for tracking consumption of virtual goods and services in a virtual world.
